(19) United States
(12) Patent Application Publication
(10) Pub. No.: US 2015/0186544 A1
(43) Pub. Date: Jul. 2, 2015

(54) WEBSITE CONTENT AND SEO MODIFICATIONS VIA A WEB BROWSER FOR NATIVE AND THIRD PARTY HOSTED WEBSITES VIA DNS REDIRECTION

(71) Applicant: Go Daddy Operating Company, LLC, Scottsdale, AZ (US)

(72) Inventors: Ryan Benedum, San Francisco, CA (US); Rajinder Nijjer, Phoenix, AZ (US); Marek Olszewski, San Francisco, CA (US); Rene Reinsberg, San Francisco, CA (US)

(21) Appl. No.: 14/626,068

(22) Filed: Feb. 19, 2015

Related U.S. Application Data
(63) Continuation-in-part of application No. 14/560,254, filed on Dec. 4, 2014.
(60) Provisional application No. 61/941,980, filed on Feb. 19, 2014.
(60) Provisional application No. 61/911,631, filed on Dec. 4, 2013.

(51) Int. Cl. G06F 17/30; G06F 17/22

(52) U.S. Cl. CPC G06F 17/30896; G06F 17/2247

(57) ABSTRACT

A system and method for search engine optimization modification to a web page using domain name system (DNS) redirection are presented. A request is received from a user for a first web page of a website via a communications network. A first computer server hosting content for the website is identified and a content of the first web page is retrieved from the first computer server. A modification for the first web page of the website is retrieved from a data storage server and applied to the content of the first web page to create a modified content of the first web page. The modified content of the first web page is transmitted to the user.

### CROSS-REFERENCE TO RELATED APPLICATIONS

This application claims priority to U.S. Provisional Patent Application 61/941,980 filed on Feb. 19, 2014 and entitled “WEBSITE CONTENT AND SEO MODIFICATIONS VIA A WEB BROWSER FOR NATIVE AND THIRD PARTY HOSTED WEBSITES VIA DNS REDIRECTION”, and is a Continuation-in-Part of U.S. patent application Ser. No. 14/560,254 filed on Dec. 4, 2014 and entitled “WEBSITE CONTENT AND SEO MODIFICATIONS VIA A WEB BROWSER FOR NATIVE AND THIRD PARTY HOSTED WEBSITES”, which claims priority to U.S. Provisional Patent Application 61/911,631 filed on Dec. 4, 2013 and entitled “WEBSITE CONTENT AND SEO MODIFICATIONS VIA A WEB BROWSER FOR NATIVE AND THIRD PARTY HOSTED WEBSITES.”

### FIELD OF THE INVENTION

The present invention generally relates to website design and communication, and, more specifically, to systems and methods for assisting a user to redesign a live website using a browser-based interface.

### BACKGROUND OF THE INVENTION

The information on web pages is in the form of programmed source code that the browser interprets to determine what to display on the requesting device. The source code may include document formats, objects, parameters, positioning instructions, and other code that is defined in one or more web programming or markup languages. One web programming language is HyperText Markup Language (“HTML”), and all web pages use it to some extent. HTML uses text indicators called tags to provide interpretation instructions to the browser. The tags specify the composition of design elements such as text, images, shapes, hyperlinks to other web pages, programming objects such as JAVA applets and JavaScript resource calls, form fields, tables, and other elements. The web page can be formatted for proper display on computer systems with widely varying display parameters, due to differences in screen size, resolution, processing power, and maximum download speeds.

For Internet users and businesses alike, the Internet continues to be increasingly valuable. Individuals and businesses depend on their online presences, particularly their websites, to deliver current and useful information to customers, readers, and other Internet users. However, website design remains a difficult skill to learn and apply effectively. Web page editors exist for helping non-programmers edit their websites using what is known as a what-you-see-is-what-you-get (WYSIWYG) interface that renders the web page source code to a display and provides editing tools for adding and modifying web page elements. It would be advantageous to provide such as WYSIWYG interface that operates on the actual website code as it is rendered in a browser, so a user can be sure that what is being edited is what will be displayed to a website visitor.

Customers frequently use Internet search engines, such as GOOGLE, BING, YAHOO, or BAIDU, to find businesses that provide the goods or services sought. The customer enters keywords relevant to the goods or services into the search engine and receive search engine results pages (SERPs) displaying websites or web pages in order of relevance to the entered keywords. In order to attract customers online, a business benefits from its website placing highly on SERPs for keywords that are relevant to its business. To improve its placement, a business may engage in search engine optimization (SEO) of its website. SEO may include modifying the code of web pages in the business's website to include strategically selected keywords in particular parts of the web pages. However, due to the volume of businesses having an Internet presence, a business may have difficulty identifying and implementing the most effective keywords for improving its SERP placement.

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting service providers typically provide the hardware, software, and electronic communication means necessary to connect multiple websites to the Internet. A single hosting service provider may literally host thousands of websites on one or more hosting servers. There are many hosting service providers, and a novice website owner may find it difficult to access and manipulate his website through the hosting service provider's resources. It would be advantageous for a WYSIWYG editing interface to be able to create website modifications for any website, regardless of its hosting service provider.

### BRIEF DESCRIPTION OF THE DRAWINGS

FIG. 1 is schematic diagram of a system and associated operating environment in accordance with the present disclosure.

FIG. 2 is a flow diagram of a first embodiment of a method for automating search engine optimization of a website in accordance with the present disclosure.

FIG. 3 is a screenshot diagram of using an interface to optimize a web page title.

FIG. 4 is a schematic diagram of a system and associated operating environment using a DNS proxy server to implement modifications to a web page in accordance with the present disclosure.

FIG. 5 illustrates a method that may be implemented by a proxy server in accordance with the present disclosure.

### DETAILED DESCRIPTION OF THE PREFERRED EMBODIMENT

The present invention overcomes the aforementioned drawbacks by providing a system and method for the modification of a live website using an editing interface that loads web pages of the live website and presents the web pages to a user along with editing and analysis tools that suggest and make changes to the website that will improve SEO. The present invention further overcomes the aforementioned drawbacks by showing the user the effects of modifications as they are made, and by executing the modifications using one or more code snippets that modify the website's document object model (DOM) as the website is loaded in a visitor's browser.

The web server tasked with serving the website to requesting devices, also known as a hosting provider, may perform one or more algorithms for website SEO, design, and design assistance, and may further perform one or more algorithms for the website creation. Alternatively, the web server may assign the SEO and website design and creation to one or more related computer systems, such as another web server, collection of web or other servers, a dedicated data processing computer, or another computer capable of performing the creation algorithms. Alternatively, a standalone program may be delivered to and installed on a personal computing device, such as the user's desktop computer or mobile device, and the standalone program may be configured to cause the personal computing device to perform the algorithms. For clarity of explanation, and not to limit the implementation of the present methods, the methods are described below as being performed by a web server that serves the web page to requesting devices.

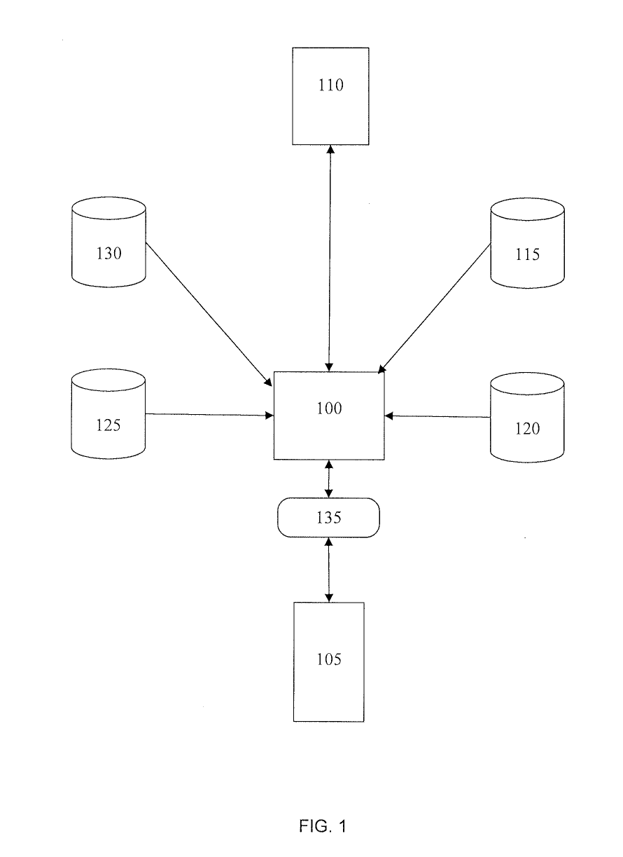

Referring to FIG. 1, a web server 100 may be configured to communicate over the Internet with one or more requesting devices 110 in order to serve requested website content to the requesting device 110. The requesting devices 110 may request the website content using any electronic communication medium, communication protocol, and computer software suitable for transmission of data over the Internet. Examples include, respectively and without limitation: a wired connection, WiFi or other wireless network, cellular network, or satellite network; Transmission Control Protocol and Internet Protocol (TCP/IP), Global System for mobile Communications (GSM) protocols, code division multiple access (CDMA) protocols, and Long Term Evolution (LTE) mobile phone protocols; and web browsers such as MICROSOFT INTERNET EXPLORER, MOZILLA FIREFOX, and APPLE SAFARI.

The web server 100 may be configured to create or modify a website that can be requested by and displayed on requesting devices 110. In some embodiments, such creation may include generating a plurality of versions of the website that convey substantially the same content but are particularly formatted to be displayed on certain requesting devices 110 or in certain browsers. For example, the web server 100 may generate a first version of the website that is formatted for PCs, and a second version of the website that is formatted for display on mobile phones. In other embodiments, such creation may include converting a website from a format that can be displayed on one type of requesting device 110 into a website that can be displayed on another type of requesting device 110. For example, the web server 100 may, upon receiving a request for the website from a mobile phone, convert the website designed to be displayed on a PC into a format that can be displayed on the mobile phone. In the present disclosure, therefore, the term website refers to any web property communicable via the Internet, such as websites, mobile websites, web pages within a larger website (e.g. profile pages on a social networking website), vertical information portals, distributed applications, and other organized data sources accessible by any device that may request data from a storage device (e.g., a client device in a client-server architecture), via a wired or wireless network connection, including, but not limited to, a desktop computer, mobile computer, telephone, or other wireless mobile device.

The web server 100 may be configured to communicate electronically with one or more data stores in order to retrieve information from the data stores. The electronic communication may be over the Internet using any suitable electronic communication medium, communication protocol, and computer software including, without limitation: a wired connection, WiFi or other wireless network, cellular network, or satellite network; Transmission Control Protocol/Internet Protocol (TCP/IP) or another open or encrypted protocol; browser software, application programming interfaces, middleware, or dedicated software programs. The electronic communication may be over another type of network, such as an intranet or virtual private network, or may be via direct wired communication interfaces or any other suitable interface for transmitting data electronically from a data store to the web server 100. In some embodiments, a data store may be a component of the web server 100, such as by being contained in a memory module or on a disk drive of the web server 100.

A data store may be any repository of information that is or can be made freely or securely accessible by the web server 100. Suitable data stores include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future; file systems; and electronic files such as web pages, spreadsheets, and documents. Each data store accessible by the web server 100 may contain information that is relevant to the creation, modification, or SEO optimization of the website, as described below. Such data stores include, without limitation to the illustrated examples: search engines 115; website information databases 120, such as domain registries, hosting service provider databases, website customer databases, and Internet aggregation databases such as archive.org; business listing data stores 125, such as YELP!, Yellow Pages, GOOGLE PLACES, LOCU, and the like; and Internet traffic databases 130 as described below.

To create or modify its website, a user may access the web server 100 with the user's device 105, which may be a PC, a mobile device, or another device able to connect electronically to the web server 100 over the Internet or another computer network. The user may be an individual, a group of individuals, a business or other organization, or any other entity that desires to publish a website that conveys information about the user or another topic, where the information may be of a commercial or a non-commercial nature, and where the website is configured to maximize its own prominence within search results for certain words related to the content of the website. For clarity of explanation, and not to limit the implementation of the present methods, the methods are described below as being performed by a web server that receives input for creating a website for a small business, such as a restaurant or bar, retail store, or service provider (e.g. barber shop, real estate or insurance agent, repair shop, equipment renter, and the like), unless otherwise indicated.

In some embodiments, the user's device 105 may interact with a user interface 135 that facilitates data collection and transmission between the device 105 and the web server 100. The user interface 135 may be implemented using hardware, software, or a combination thereof. The user interface 135 may reside in the memory of the web server 100, of the user's device 105, or of a distinct computer server or other computing device.

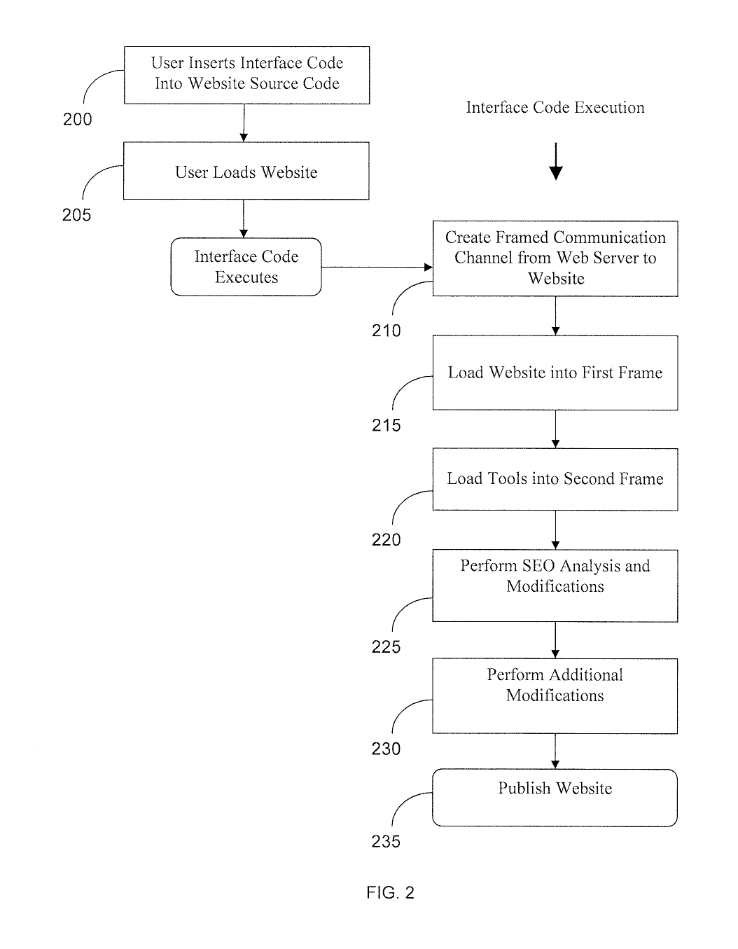

Referring to FIG. 2, the presently described interface between the web server 100 and the target website to be modified may be accessed using one or more interface code snippets inserted into the source code of one or more web pages in the target website. The code snippets may be a JavaScript function call configured to initiate the interface and connect the web server 100 to the target website as described below. At step 200, the user may insert the interface code into one or more of the web pages using any suitable website design tool, including a hosted design platform such as PLESK or a design tool provided by a content management system such as WORDPRESS. At step 205, the user loads the website into the user's browser, which causes the interface code to execute and activate the interface.

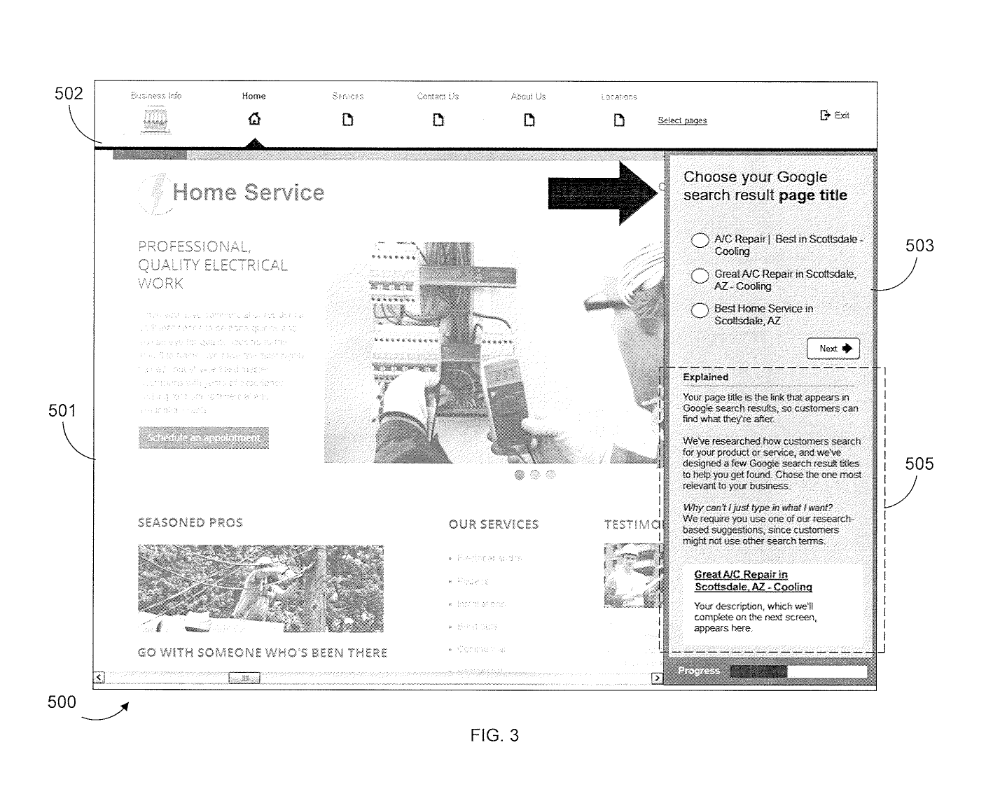

At step 210, the interface creates a communication channel between the target web page and the web server 100. The communication channel may be facilitated using a plurality frames, such as IFRAMES, created by the interface. At step 215, the target website is loaded into a first frame. The target website may be rendered as it would appear in the user's browser if normally visited by the user. At step 220, one or more modification tool sets may be loaded into a second frame appearing next to, above, or below the first frame. The communication between the first and second frames allows the web server 100 to see into the “inner workings,” i.e., the source code and layout, of the web page directly from a visitor's browser and perform the analysis and modification of the website as described below. As shown in the example of FIG. 3, the user may view the original website in the first frame 501 of the interface 500, selector buttons for the web pages in a second frame 502, and modification instructions in a third frame 503.

At step 225, the web server 100 may perform SEO analysis of one or more of the web pages. In the illustrated method and other methods according to this disclosure, SEO analysis may include identifying one or more valuable keywords and incorporating the keywords into the user's website. A keyword's value derives from its relevance to goods, services, or content offered for sale or otherwise provided by the user, such that the user desires its website to place highly on SERPs for searches that include the keyword. The methods of the present invention may use any suitable methodology for identifying a set of keywords that are pertinent to the user's website. Preferably, such methodologies are partially or fully automated, such as by scraping information from the source code of the web pages and performing keyword identification on the information, but in some embodiments the keywords may be supplied by the user or another entity through manual entry of the keywords in an interface. SEO analysis may include other methods of identifying data on the web page that is relevant to SERP placement or indexing of the web page. For example, the web server 100 may identify a navigation breadcrumb or a store address on the web page, in order to semantically tag the store address as described below. SEO analysis may further include identifying keywords or other information relevant to SERP placement or web page indexing using data obtained from another data store, such as the data stores 115-130 described above with respect to FIG. 1.

From results obtained in the SEO analysis, the web server may suggest modifications to the website that will improve SEO of the web page. The web server 100 may assist the user to select the most suitable keywords and place them into strategic positions on a particular web page, in order to optimize the web page for prominent placement on SERPs of one or more search engines. A strategic position is a section of HTML code in which the content is given a high weight in search engine indexing algorithms. For example, the GOOGLE indexing algorithm considers words in the web page title (i.e., the <title> HTML tag) to have the most relevance to the subject matter of the web page and gives the title the most weight, while on-page content such as headlines (i.e., <h1> and <h2> HTML tags), paragraphs, images, and the like, have decreasing, but still valuable, weight. FIG. 3 illustrates an example of assisting a user to select an appropriate web page title. In some embodiments, the keyword insertion may be guided by educational displays 505. In some embodiments, the web server 100 may present pre-formatted suggestions for the content to be inserted into the web page, and may automatically insert the content as described below. In some embodiments, the web server 100 may automatically insert non-rendered markup, such as Microdata or RDFa tags, to identify data on the web page that should receive additional indexing or display formatting in a search engine index.

At step 230, the web server 100 may perform additional modifications to the web page design as input by the user. Such modifications may include relocating or resizing page elements, changing text or images, and performing other design changes that the user may view in real-time in the first frame.

As modifications are made at steps 225 and 230, the web server 100 may generate code snippets, such as JavaScript instructions, that will apply the modifications to the original source code of the target website. That is, the original source code of the target website may not be edited, but instead the web server 100 may create a revised DOM for the website that is loaded through the code snippet inserted by the user at step 200 or subsequently to that step, such as at publication of the changes. At step 235, the interface may be instructed to publish the modified website, which causes the web server 100 to store the modifications locally. The modifications are then retrieved by the code snippet call on subsequent page loads, and the web page is rebuilt in real-time in a visitor's browser.

In an alternative implementation, rather than require that JavaScript or some other program code be inserted into the source code of the one or more web pages in the target website in order to access the described user interface, a similar function may be provided using a proxy server. By redirecting traffic to the website to the proxy server instead, the proxy server can overlay the desired target web page with a user interface enabling the target web page to be edited or otherwise modified. The proxy server may also be configured to implement SEO optimization modifications to the web page before it is served to a third party. The proxy server can then store those modifications so that when the target web page is accessed by a third party in the future, the proxy server can implement those modifications to the target web page before serving the web page (now modified) to the requesting third party.

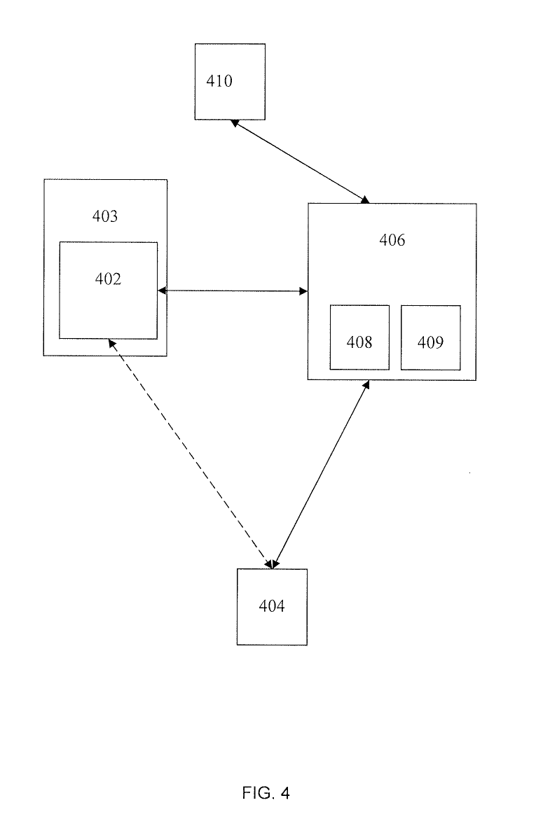

To illustrate, FIG. 4 is a schematic diagram of a system and associated operating environment using a DNS proxy server to implement modifications to a web page in accordance with the present disclosure. With reference to FIG. 4, a user has initially created a web page 402. Web page 402 may be one web page of many that make up an entire web site and is hosted on server 403. Web page 402 may have been created using any suitable method. For example, web page 402 may have been constructed by a user directly editing the code that makes up the web page 402 via a text editor. Alternatively, web page 402 may have been constructed using a WYSIWYG editing tool, or a web-based interface to facilitate the creation and revision of web page content.

At some point, however, the user may wish to edit, revise, optimize, or otherwise change web page 402 using the present modification interface. In this example, the modification user interface 408 is provided via proxy server 406. To make use of the interface 408, the user updates the DNS entry for the domain name associated with web page 402 to point at proxy server 406. The user then accesses web page 402 as normal.

Because the DNS entry has been updated, the user's computing device 404, upon attempting to retrieve the content of web page 402, communicates with proxy server 406 (see the solid arrow) rather than the server 403 hosting web page 402 directly (see the dashed arrow). Proxy server 406, upon receipt of the request from the user's computing device 404 (which includes an HTTP request identifying web page 402) is configured to retrieve the content of web page 402 from the server 403 hosting web page 402 (proxy server 406 may identify the server 403 hosting web page 402 via a lookup table or other suitable database providing information enabling proxy server 406 to identify the server hosting web page 402 and communicate with that server). Proxy server 406 then, once the content of web page 402 has been retrieved, overlays the content of web page 402 with user interface 408, which enables revision of the web site content (see, for example, the user interface depicted in FIG. 3). This content, the combination of web page 402 with the appropriate user interface 408, is then transmitted back to the user's computing device 404. The user can then utilize the user interface to make revisions to web page 402 as desired. As discussed above, these revisions may include modifying or updating content of web page 402, SEO of web page 402, or any other revisions enabled by user interface 408.

As the user makes changes to web page 402 using the user interface provided by proxy server 406, proxy server 406 can store those changes in a suitable format in a database contained within data storage server 409. In one embodiment, the changes may be stored in a database where, for each change, a string version of the web page source that needs to be modified is stored along with a string version of what that web page source needs to be updated to. In one embodiment, this information may be stored in a JavaScript Object Notation (JSON) format. An example of such a format is shown below in Table 1.

TABLE 1

{

“url”: “http://neednot2know.com/index”,
“edits”: [
{

“tracking”: {
“id”: “852”
},
“old”: “</head>”,
“type”: “replace”,
“mode”: “first”,
“new”: “<title>Awesome Sauce - plumbing, pipe leaks,

plumbing problems</title></head>”,

“conditions”: [
{

“text”: “<title”,
“invert”: true,
“type”: “contains”

}
]

},

...

As such, proxy server 406, by providing user interface 408, enables the user to define a number of changes that the user wishes to apply to the content of web page 402. In some cases, access to the user interface 408 to modify web page 402 will only be provided by proxy server 406 when the user requesting web page 402 has supplied appropriate authentication credentials allowing for revision of web page 402. In some embodiments on a single set of authentication credentials (e.g., a password, secret phrase, biometric data point, etc.) may be provided as part of the authentication process. In other embodiments, multi-factor authentication may be utilized to authenticate the user, thereby enabling optional changes and modifications to be made to various web pages of the website.

Once the user has defined a set of changes he or she wishes to make to web page 402 and those changes are stored on proxy server 406 (or another suitable data storage system accessible to proxy server 406), when web page 402 is requested in the future, proxy server 406 can apply those changes to web page 402 before serving up web page 402 to other users. As such, users will be provided with a version of the web page 402 that include the modifications specified by the user.

For example, if a third party wishes to view web page 402, the third party's computer 410 would request web page 402 by communicating with proxy server 406 (because the DNS records for the domain name associated with web page 402 now point to proxy server 406). In response to the user's request for a particular web page, proxy server 406 would then retrieve the content of the requested web page 402 from the server hosting web page 402. Proxy server 406 would then implement any changes as defined by the user and transmit the revised web page 402 to content to the third party's computer 410.

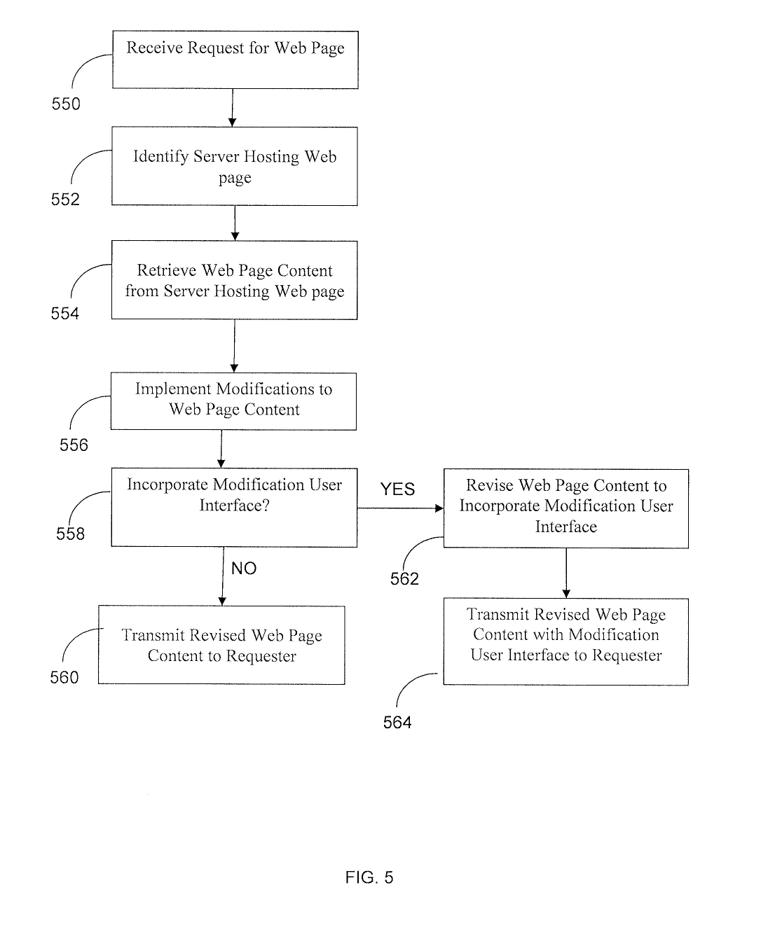

FIG. 5 illustrates a method that may be implemented by proxy server 406 in accordance with the present disclosure. In step 550, the proxy server receives a request for a web page. The request may include an HTTP request that identifies the web page, as well as a domain name of the web page.

In step 552, the proxy server identifies the server hosting the requested web page. This may involve the proxy server using a look up table, database, or other data source to identify an Internet Protocol (IP) address or other locating information for the server (e.g., server 403 of FIG. 4) hosting the requested web page.

In step 554, having identified the server hosting the requested web page, the proxy server retrieves the requested web page's content from that server.

In step 556, the proxy server modifies the retrieved web page content using any previously stored changes or additions that may have been defined for the requested web page. As discussed above, these will generally be defined by a user using a suitable user interface to modify content on the web page, or add new content to the web page. In some cases, the changes may be made automatically, for example, to improve a search engine visibility of the web page, or to improve the performance of the web page.

In various embodiments, the changes made to the web page's content may include one or more of updating the web page's title tag to a more SEO optimized version, inserting a new title tag into the web page's head tag, updating the web page's description tag with a more SEO optimized version, inserting a new description title tag into the web page's head tag, updating a web page's headline (h1) tag to include a chosen focus keyword, updating web page content to include specific keywords chosen by a user of a search engine visibility tool, automatically inserting social buttons onto a page to allow clients to share the page in social networks, and confirming that all necessary meta tags in the web page are present and correctly placed within the web page.

In step 558, the proxy server makes a determination as to whether to incorporate into the requested web page the modification interface (such as the interface described above an illustrated in FIG. 3). This determination may be made based upon a number of factors. For example, if the proxy server has received authentication tokens from the requester indicating that the requester has permission to revise the web page, the proxy server may include the modification interface enabling the user to make adjustments and modifications to the web page. In some cases, if the request is received from a particular IP address or set of IP addresses, the proxy server will be configured to incorporate the modification interface. In some cases, the modification interface will always be incorporated into the web page.

If however, in step 558 the proxy server determines that the web page should not incorporate the modification user interface (this will often be the case when the web page is requested by a third party unrelated to the owner of the web page), the proxy server will, in step 560, transmit the modified web page content, with no modification user interface, to the requester. As such, the requester will receive, in response to his or her request, the updated web page content.

If, however, in step 558 the proxy server determines that the modification user interface should be incorporated into the web page, in step 562 the proxy server adds the modification user interface to the revised web page content. As discussed above, the modification user interface may, in one embodiment, be incorporated into the revised web page content using frames or other techniques by which to insert particular user interface devices into the revised web page content.

Then, in step 564 the proxy server transmits the revised web page content, in combination with the modification user interface, to the requester. The requester can then use the modification user interface to modify or add content to the web page.

The use of a proxy server to implement revisions of web page content, as described above and with respect to FIGS. 4 and 5, may, in some cases, present benefits over the reliance on JavaScript to implement the web page content modifications. For example, because some web search crawlers do not execute JavaScript, the use of a proxy server instead of JavaScript ensures that those crawlers analyze the most up-to-date version of the web page. This is because the proxy server will implement those changes before serving the revised web page content to a particular crawler bot. In fact, in some implementations the proxy server is configured to always implement particular revisions to web page content in order to provide SEO. In that case, the changes may not be made by a user and may instead be made by the proxy server according to a set of predefined rules. In that case, the proxy server may optionally be provided with the capability to also provide the modification user interface.

Additionally, the use of a proxy server may provide a simpler solution to an end user as it only requires the revision of the web site's DNS records and not the insertion of particular program code into one or more web pages of the web site. In situations in which the user's DNS host is the operated by the same entity as the user's hosting services, the change to the DNS records may be implemented automatically.

In one embodiment of the present system, the user may not even be required to update DNS records for the website in order to implement the present proxy server system for implementing modifications to a web page in accordance with the present disclosure. If, for example, the proxy server (e.g., proxy server 406 of FIG. 4) is operated by the user's hosting provider and the hosting provider manages the user's DNS records for the user's website, the user may log into a domain management service with the hosting provider. Once logged in, the user may be provided with an option to implement the present proxy server methodology for the user's website.

Before causing the proxy server methodology to be implemented for the user's website, the user's website may be configured in a conventional manner. For example, with reference to FIG. 4, the user's website may be hosted on a server 403, and the DNS records for the website (managed by the hosting provider) may simply point to the server 403 so that the user's website can be directly accessed and retrieved.

Once, however, the user indicates that the proxy server methodology should be implemented for the user's website, the hosting provider could, automatically and without any input from the user, update the user's DNS records to point the domain name associated with the user's website to the proxy server (e.g., proxy server 406 of FIG. 4). At the same time, the hosting provider could store in a database record that is accessible to the proxy server an indication that the original content for the user's website is stored on a server having the IP address of server 403. By storing this record, the proxy server, upon receiving a request for one or more web pages from the user's website, can access the record to determine where the user's original website content is stored. The proxy server can then retrieve that original website content, apply modifications and changes to the website content (either as the result of changes created and specified by the user—for example, using the modification user interface, the result of search engine optimization analysis performed on the original website content, the result of performance optimizations applied to the original website content, or the like), and transmit the resulting website content back to the requesting user.

In the manner, the present proxy server methodology may be implemented for a website without requiring that a user modify any DNS records for their website or any other complicated changes.

Finally, the proxy server could be configured to implement caching to speed up serving of the revised web page content. In that case, the proxy server would be configured to cache versions of web page after their content has been modified in accordance with any changes stored by the proxy server or accordingly to certain SEO rules. The proxy server can then serve those revised versions from the cache. Assuming that the proxy server is a higher performance server than the server current hosting the web page, that could provide additional performance benefits, too. Alternatively, the proxy server may cache the original website content on the proxy server. Then, upon receiving a request for one of the web pages of the website, the proxy server can retrieve the locally stored copy of the original website content and apply any defined changes to the original website content before serving the revised website content up to a requester. In such a configuration, the copy of the website stored on the proxy server could be stored permanently so that even if the original website content is taken down, or the server hosting the original website content should become unavailable or be hosted at a new IP address, the proxy server will still have access a copy of the original website content.

In one embodiment, a system includes a first computer server hosting a plurality of web pages of a website, a data storage server configured to store a plurality of modifications to the website, and a proxy server in communication with the data storage server. The proxy server is configured to receive, via a communications network, a request from a user for a first web page of the website, retrieve a content of the first web page from the first computer server, retrieve a modification for the first web page of the website from the data storage server, apply the modification to the content of the first web page to create a modified content of the first web page, and transmit the modified content of the first web page to the user. The system includes a domain name system (DNS) server storing a DNS record associating a domain name of the website with an Internet protocol (IP) address of the proxy server.

In another embodiment, a proxy server includes a processor configured to receive, via a communications network, a request from a user for a first web page of a website, identify a first computer server hosting content for the website, retrieve a content of the first web page from the first computer server, retrieve a modification for the first web page of the website from a data storage server, apply the modification to the content of the first web page to create a modified content of the first web page, and transmit the modified content of the first web page to the user.

In another embodiment, a method includes receiving, via a communications network, a request from a user for a first web page of a website, identifying a first computer server hosting content for the website, retrieving a content of the first web page from the first computer server, retrieving a modification for the first web page of the website from a data storage server, applying the modification to the content of the first web page to create a modified content of the first web page, and transmitting the modified content of the first web page to the user.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

We claim:

1. A system, comprising:
a first computer server hosting a plurality of web pages of a website;
a data storage server configured to store a plurality of modifications to the website;
a proxy server in communication with the data storage server, the proxy server being configured to:
receive, via a communications network, a request from a user for a first web page of the website,
retrieve a content of the first web page from the first computer server,
retrieve a modification for the first web page of the website from the data storage server,
apply the modification to the content of the first web page to create a modified content of the first web page, and
transmit the modified content of the first web page to the user; and
a domain name system (DNS) server storing a DNS record associating a domain name of the website with an Internet protocol (IP) address of the proxy server.

2. The system of claim 1, wherein the modification includes a change to at least one of a title hyper-text markup language (HTML) tag, and a headline HTML tag of the first web page.

3. The system of claim 1, wherein the modification to the first web page is encoded as Javascript.

4. The system of claim 1, wherein the proxy server is further configured to include in the modified content of the first web page a user interface for modifying the first web page.

5. The system of claim 4, wherein the proxy server is configured to, before including in the modified content of the first web page the user interface for modifying the first web page, determine whether the user has sufficient authority to modify the first web page of the website.

6. The system of claim 5, wherein the proxy server is configured to determine whether the user has sufficient authority by analyzing an authentication token received from the user.

7. The system of claim 5, wherein the proxy server is configured to determine whether the user has sufficient authority by analyzing an Internet protocol address from which the request originated.

8. The system of claim 1, wherein the proxy server is configure to cache a copy of the content of the first web page.

9. A proxy server, comprising:
a processor, the processor being configured to:
receive, via a communications network, a request from a user for a first web page of a website,
identify a first computer server hosting content for the website,
retrieve a content of the first web page from the first computer server,
retrieve a modification for the first web page of the website from a data storage server,
apply the modification to the content of the first web page to create a modified content of the first web page, and
transmit the modified content of the first web page to the user.

10. The proxy server of claim 9, wherein the modification includes a change to at least one of a title hyper-text markup language (HTML) tag, and a headline HTML tag of the first web page.

11. The proxy server of claim 9, wherein the modification to the first web page is encoded as Javascript.

12. The proxy server of claim 9, wherein the processor is further configured to include in the modified content of the first web page a user interface for modifying the first web page.

13. The proxy server of claim 12, wherein the processor is configured to, before including in the modified content of the first web page the user interface for modifying the first web page, determine whether the user has sufficient authority to modify the first web page of the website.

14. The proxy server of claim 13, wherein the processor is configured to determine whether the user has sufficient authority by analyzing an authentication token received from the user.

15. The proxy server of claim 13, wherein the proxy server is configured to determine whether the user has sufficient authority by analyzing an Internet protocol address from which the request originated.

16. The proxy server of claim 9, wherein the processor is configure to cache a copy of the content of the first web page.

17. A method, comprising:
receiving, via a communications network, a request from a user for a first web page of a website,
identifying a first computer server hosting content for the website,
retrieving a content of the first web page from the first computer server,
retrieving a modification for the first web page of the website from a data storage server,
applying the modification to the content of the first web page to create a modified content of the first web page, and
transmitting the modified content of the first web page to the user.

18. The method of claim 17, including:
determining whether the user has sufficient authority to modify the first web page of the website; and
when the user has sufficient authority to modify the first web page, including in the modified content of the first web page a user interface for modifying the first web page.

19. The method of claim 18, including analyzing an authentication token received from the user.

20. The method of claim 18, including analyzing an Internet protocol address from which the request originated.
